(19) United States
(12) Patent Application Publication
(10) Pub. No.: US 2025/0348729 A1
(43) Pub. Date: Nov. 13, 2025

(54) PROFILE-GUIDED QUANTIZATION OF NEURAL NETWORKS

(71) Applicant: Google LLC, Mountain View, CA (US)

(72) Inventors: Chiachen Chou, Burlingame, CA (US); Mitchelle Margaret Rasquinha, Mountain View, CA (US); Gil Joseph Tabak, Boulder, CO (US); Zongwei Zhou, Mountain View, CA (US); Naveen Kumar, San Jose, CA (US); Denali Marie Molitor, Seattle, WA (US); Xiaofan Zhang, Santa Clara, CA (US); Navid Shirzad, Seattle, WA (US); Xiaofei Guo, Santa Clara, CA (US); Aditya Binodkumar Agrawal, Santa Clara, CA (US); Philip Grant Hendrix, Santa Cruz, CA (US)

(21) Appl. No.: 18/661,257

(22) Filed: May 10, 2024

(51) Int. Cl. G06N 3/08; G06F 8/41

(52) U.S. Cl. CPC G06N 3/08; G06F 8/41

(57) ABSTRACT

Methods, systems, and apparatus, including computer programs encoded on computer storage media, for generating machine code for a quantized neural network. In one aspect, one of the methods include: receiving source code for a neural network, and performing a profile-guided quantization process to generate an optimized quantization configuration for the neural network that defines, for each of the plurality of layers, one or more optimized computer number formats for representing activation values generated by the layer, the respective sets of parameters for the layer, or both.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

A general trend with machine learning models is that they are becoming larger and more computationally intensive. For example, large-scale neural networks, e.g., neural networks with millions, billions, or more parameters, are now being used to solve problems in natural language processing, image processing, computer vision, robotics, and health care. A large-scale neural network can have a very large memory footprint. As a consequence, mobile devices and embedded systems with limited memory resources, such as laptops, tablets, and smartphones, can be incapable of storing a large-scale neural network. Even if the neural network can be stored on such a device, it can consume a significant amount of the available memory resources.

Moreover, training large-scale neural networks generally results in significant carbon dioxide (CO2) emissions and a significant amount of electricity usage, e.g., because the data sets on which the training is done are extremely large and the models have significant numbers of parameters.

### SUMMARY

This specification generally describes systems, methods, devices, and related techniques for compiling source code for a neural network into machine code and quantizing parameters of the neural network in a manner that reduces the memory footprint, the computational costs, the latency, or a combination thereof of the machine code.

Particular embodiments of the subject matter described in this specification can be implemented so as to realize one or more of the following advantages.

In some implementations, the techniques described in this specification involve quantizing a neural network by executing an iterative, profile-guided quantization process with no or minimal human expert involvement. By executing a quantization process guided by statistical and/or topological profiles of the neural network, a system can automatically generate a compressed neural network with acceptable, e.g., negligible, degradation in prediction accuracy.

The profile-guided quantization techniques disclosed herein can be scaled and generally applied to neural networks having any of a variety of architectures, including feedforward neural networks, convolutional neural networks, recurrent neural networks, and transformer neural networks. The profile-guided quantization techniques can likewise be applied to one or more portions of a neural network, e.g., to individual layer(s) of a neural network, and with respect to a variety of machine learning workload types and applications (e.g., large language models). Furthermore, the described techniques can advantageously quantize neural networks at the compiler level without requiring changes to the underlying source code for the neural networks. This eliminates errors that can otherwise result from source code changes.

In some examples, the techniques described in this specification can be advantageously applied to generate a quantized version of a large neural network with a reduced size more quickly by searching through a reduced search space, or with less human input than if a heuristic or brute-force search process were employed. Because the profile-guided quantization process is fast, the described techniques significantly reduce the carbon dioxide (CO₂) footprint of the quantization process while also significantly reducing the amount of electricity consumed by the quantization process.

In some examples, the profile-guided quantization process can unencumber developers from having the expertise or the time to manually quantize models. This is particularly important when high development velocity is desirable. This is also useful when offering infrastructure for developing on running neural networks (e.g., TPUs or GPUs in cloud environments) where users can avail of the faster execution time enabled through the profile-guided quantization process.

The smaller quantized model that can be generated as a result of executing the profile-guided quantization process can require less memory resources to store and will also often be faster to run or, stated differently, exhibit less latency. Thus, some aspects of the present specification enable savings of computing resources such as memory usage, processor usage, network bandwidth, and the like. By reducing the size of the neural network, it can more easily be deployed to perform on-device inference in a resource-constrained environment such as a mobile or edge device, and can additionally make better use of existing computing hardware, including lower-precision arithmetic hardware. By enabling on-device inference, latency experienced by the user can further be reduced as round trip communication to a higher order device, e.g., a cloud server, can be eliminated. Likewise, user privacy can be enhanced as prompt text can be processed on the device, without being transmitted to the cloud server.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network quantization system and an example runtime environment.

FIG. 2 is a flow diagram of an example process for generating machine code for a final quantized version of a neural network.

FIG. 3 is a flow diagram of sub-steps of one of the steps of the process of FIG. 2.

Like reference numbers and designations in the various drawings indicate like elements.

### DETAILED DESCRIPTION

This specification generally describes systems, methods, devices, and related techniques for compiling source code for a neural network into machine code and quantizing parameters of the neural network in a manner that reduces a memory footprint of the machine code.

The neural network can be configured to receive a digital data input and to perform a prediction task (e.g., generative task, classification task, or regression task) on the input to generate an output. A few examples follow.

In some cases, the neural network is a neural network configured to perform an image processing task, e.g., to receive an input image and to process the input image to generate a network output for the input image. For example, the task can be an image classification task and the output generated by the neural network for a given image can be scores for each of a set of object categories, where each score represents an estimated likelihood that the image includes a depiction of an object belonging to the category. As another example, the task can be an image embedding generation task and the output generated by the neural network can be a numeric embedding of the input image. As another example, the task can be an object detection task and the output generated by the neural network can identify locations in the input image at which particular types of objects are depicted in the image. As yet another example, the task can be an image segmentation task and the output generated by the neural network can assign each pixel or group of pixels of the input image to a particular category in a defined set of categories. In some other cases, the neural network is configured to perform an image generation task, where the input is a conditioning input and the output is a sequence of intensity value inputs for the pixels of an image.

As one example, the task can be a neural machine translation task. For example, if the input to the neural network is a sequence of text, e.g., a sequence of words, phrases, characters, or word pieces, in one language, the output generated by the neural network can be a translation of the sequence of text into another language, i.e., a sequence of text in the other language that is a translation of the input sequence of text. As a particular example, the task can be a multi-lingual machine translation task, where a single neural network is configured to translate between multiple different source language-target language pairs. In this example, the source language text can be augmented with an identifier that indicates the target language into which the neural network should translate the source language text.

As another example, the task can be an audio processing task. For example, if the input to the neural network is a sequence representing a spoken utterance, the output generated by the neural network can be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations can comprise sensor data captured by sensors associated with (e.g. part of) the agent, for example visual data, LIDAR data, sonar data, agent configuration data (e.g. joint angles), agent orientation data, or the like.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks (e.g., sub-tasks) and the system is configured to perform multiple two or more of machine learning tasks such as those described above. For example, the neural network can be configured to perform multiple individual natural language understanding tasks, with the input including an identifier for the individual natural language understanding task to be performed on the network input.

In some cases, the task is a multi-modal task that requires processing both text and image inputs, so that the neural network includes both a computer vision neural network component and a text processing neural network component. For example, the target output to be generated by the computer vision neural network component for a given image can depend on one or more outputs generated by the text processing neural network component for one or more corresponding text inputs (and vice versa). Examples of such tasks include open-vocabulary image classification, open-vocabulary object detection, image captioning, text-based image search, image-based retrieval, and so on.

More generally, the multi-modal processing task can correspond to any of the tasks previously described for any of the types of data making up the multi-modal combination. For example, an accuracy of the previously described tasks can be increased when the task is applied to multi-modal data combining the data for which the task has been previously described and another type of data. For example, detection or classification of an object or event can be improved when data of multiple different types (modalities) is processed.

The neural network can generally employ any appropriate architecture for performing the desired task. Examples of neural network architectures compatible with the disclosed quantization techniques include convolutional architectures, recurrent architectures, fully-connected architectures, e.g., multi-layer perceptron (MLP) architectures, encoder-only Transformer architectures, encoder-decoder Transformer architectures, decoder-only Transformer architectures, other attention-based architectures, and so on.

In some situations, the neural network can be referred to as an auto-regressive neural network when the neural network auto-regressively generates an output sequence of tokens. More specifically, the auto-regressively generated output can be created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the neural network can be an auto-regressive Transformer-based neural network that includes (i) a plurality of attention blocks that each apply a self-attention operation and (ii) an output subnetwork that processes an output of the last attention block to generate the score distribution. In implementations the neural network can be configured as, or include, a generative (large) language model or a multi-modal model, e.g., a visual and language model, to perform these example machine learning tasks.

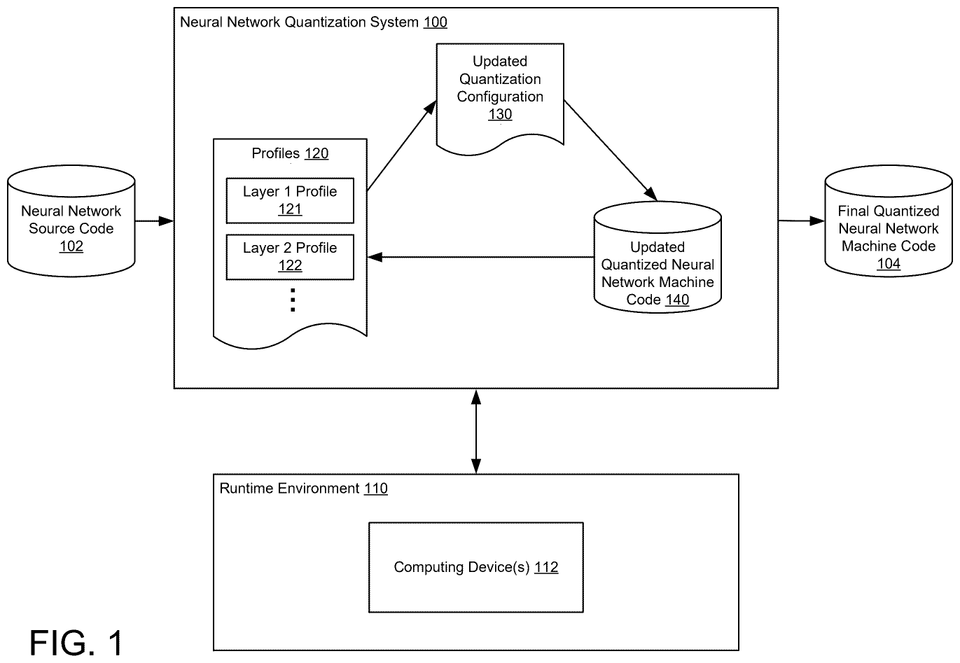

FIG. 1 shows an example neural network quantization system 100 and an example runtime environment 110. The quantization system 100 is an example of a system implemented with one or more computer programs on one or more computers in one or more locations, in which techniques described in this specification can be implemented.

The quantization system 100 obtains source code 102 for a neural network and compiles the source code 102 into machine code 104 for a quantized version of the neural network. The neural network can be any neural network discussed above. Then, the quantization system 100 outputs the machine code 104 to the runtime environment 110 for deployment of the neural network having the quantized version in the runtime environment 110 to perform any of the tasks mentioned above.

The runtime environment 110 includes one or more computing devices 112. The computing devices 112 can include central processing units (CPUs), tensor processing units (TPUs), graphics processing units (GPUs), or special-purpose processors, such as field programmable gate arrays (FPGAs), or application specific integrated circuits (ASICs), that form at least a portion of the hardware circuits for executing software routines of the computing devices 112. The runtime environment 110 can include any number of computing devices 112, e.g., a single CPU, TPU, or GPU, multiple CPUs, TPUs, or GPUs, or multiple different types of computing devices, e.g., two or more of CPUs, TPUs, or GPUs,

The source code 102 can be obtained in any suitable manner. For example, the quantization system 100 can receive the source code 102 defining the neural network as an upload from a remote user of the system over a data communication network, e.g., using an interface made available by the system. The interface can be a command-line interface (CLI), a graphical user interface (GUI), an application programming interface (API), or various combinations of the three and possibly another user interface (e.g., a web browser as user interface). In this example, known libraries or frameworks can be provided within the interface to the user, e.g., developer, to provide support for the user to write source code that facilitates the creation, training, and/or evaluation of the neural network. Examples of such libraries include TensorFlow and JAX.

As another example, the quantization system 100 can receive an input from a user specifying which source code that is already maintained by the system, or stored in some source code repository that is accessible by the system, should be used as the source code 102 for the neural network.

The source code 102 can be written in any of a variety of high-level programming languages. Some familiar examples of high-level programming languages include C, C++, Java, Python, to name a few. For example, the source code 102 can define in code form the number of layers in the neural network, the operations performed by each of the layers (or by corresponding nodes of each of the layers), and the connectivity between the layers in the neural network, i.e., which layers receive inputs from which other layers in the neural network.

Optionally, in some cases, the quantization system 100 obtains metadata as part of, or together with, the source code 102 for the neural network. The metadata can include information about a target runtime environment, e.g., the runtime environment 110 in FIG. 1, to perform the operations of the layers of the neural network (or operations of the corresponding nodes of each of the layers).

The metadata can include an identification of certain hardware capabilities of the target runtime environment, e.g., available computing resources, memory capacity, power consumption, and so on of the computing devices 112 included in the runtime environment 110. The identification can be direct, e.g., where the metadata includes information that defines the hardware capabilities, or can alternatively be indirect, e.g., wherein the metadata includes an identifier of a target runtime environment the hardware capabilities of which is known.

Additionally, or alternatively, the metadata can include information about target runtime behaviors of the neural network. For example, the metadata can include an identification of the maximum allowable computing resource or memory or power consumption, maximum allowable inference latency, or both, after the neural network has been deployed for execution in the runtime environment 110.

The machine code 104 can be specified in a programming language (typically a lower-level programming language) that is different than the source code 102. Some familiar examples of machine code include compiled code, microcode, firmware code, binary code, native code, object code, assembly language code, p-code, bytecode, dynamic link library code, and common intermediate language (CLI) code, to name a few.

To generate machine code 104 for the quantized neural network from the source code 102 for the neural network, the quantization system 100 executes a profile-guided quantization process across multiple iterations.

At each iteration of the profile-guided quantization process, the quantization system 100 obtains current profile(s) 120 for the neural network based on information obtained as a result of processing a machine learning workload with a current quantized version of the neural network and identifies an updated quantization configuration 130 for the neural network based on the current profiles 120. Then, the quantization system 100 generates, in accordance with the updated quantization configuration 130, machine code for an updated quantized version of the neural network. In some cases, the updated quantized version of the neural network can be a quantized, i.e., compressed, representation of the neural network obtained at the end of each iteration.

For example, the machine learning workload can be a neural network training workload that contains training data on which the neural network is trained. Generally, the training data includes a set of neural network inputs and, for each neural network input, a respective target output that should be generated by the neural network to perform the particular task. As another example, the machine learning workload can be a neural network inference workload that includes computations for computing an inference using a neural network.

In some cases, the machine learning workload can be a test workload with a relatively small size, e.g., that involves making a few hundred forward passes through the neural network and, in the case of a training workload, a few hundred backward passes through the neural network.

The quantization system 100 processes a machine learning workload by executing the machine code for a current quantized version of the neural network and providing the workload as an input to the neural network. If the given iteration is a subsequent iteration after the first (initial) iteration, the current quantized version of the neural network can be the quantized version of the neural network that has been generated in accordance with a quantization configuration that was identified in an immediately preceding iteration of the profile-guided quantization process. Techniques for generating such a quantization configuration are discussed further below.

If the given iteration is the first (initial) iteration in the profile-guided quantization process, because there is no previously generated quantized configuration, the current quantized version of the neural network can be initially quantized using a default quantization configuration or otherwise according to a quantization configuration defined by the source code 102 for use during development, training, and/or evaluation of the neural network.

The quantization system 100 monitors execution of the workload by the current quantized version of the neural network and uses the data collected from the monitoring to update the profiles 120, i.e., to generate updated profiles 120 for use in generating an updated quantized version of the neural network for the next iteration. In some implementations, the quantization system 100 maintains one or more respective profiles 120 for each layer of the neural network. Different layers of the neural network can have different profiles 120. FIG. 1, for example, illustrates that a corresponding profile 121 for a first layer of the neural network, a corresponding profile 122 for a second layer of the neural network, and so on, where the profile 122 is different from the profile 121. In some implementations, respective profiles 120 can be defined not only for individual layers but additionally or alternatively for multiple layers or other defined portions of the neural network.

In some implementations, profiles 120 are statistical profiles. That is, for a given portion (e.g., layer) of the neural network, the corresponding profile can include statistical information about values of one or more of: the inputs, the outputs (e.g., the activations), or the parameters (e.g., weights and, optionally, biases) of the nodes in that portion (e.g., layer) of the neural network. As a particular example, statistical information about the outputs of a given layer can represent the activation level of neurons included in the given layer during the machine learning workload. In fact, the statistical information can be generated for any smaller portion of the neural network, e.g., along each non-contracting dimension of the inputs to, or outputs of a layer of the neural network.

For example, the statistical information can include one or more of: a maximum value, a mean value, a minimum value, or a central tendency value (e.g., a median value, a mean value, or another central tendency value) of such values. As another example, for the given layer of the neural network, the corresponding profile can identify a set of commonly used parameter values, common patterns that appear within the parameter values, and so on.

For another example, statistical information can include profiles that capture structural properties of the underlying data, such as sparsity, and in the case of matrices their rank.

In some implementations, the profiles 120 are topological profiles. That is, for a given portion (e.g., layer) of the neural network, the corresponding profile can include topological information about that portion of the neural network. For example, the topological information can indicate whether a given layer has a recurrent connectivity, a feed forward connectivity, or a skip connectivity to other layers of the neural network. As another example, the topological information can identify the location of a given layer within the neural network, e.g., whether it is near the input head or the output head of the neural network.

In some implementations, the profiles 120 include semantic profiles. For example, the semantic information can indicate whether a tensor associated with the neural network includes values that represent the inputs, the outputs (e.g., the activations), the parameters (e.g., weights and, optionally, biases), or the gradients of a given layer of the neural network. Additionally, the semantic information can indicate whether the values are used in a forward or backward pass through the neural network.

In some implementations, the profiles 120 include other metadata profiles. For example, the metadata can indicate the shapes of tensors associated with the neural network.

In some implementations, the profiles 120 include some combination of two or more of the profiles mentioned above, e.g., both statistical profiles and topological profiles.

At each of the multiple iterations across the profile-guided quantization process, the quantization system 100 uses the profiles 120 to generate an updated quantization configuration 130 for the neural network for the iteration, and subsequently compiles the source code 102 for the neural network in accordance with the updated quantization configuration to generate machine code 140 for an updated quantized version of the neural network.

In some implementations, the updated quantization configuration 130 for the neural network defines how to quantize values associated with the neural network. Quantizing a value refers to constraining a value from a large and/or more precise set of values to a smaller and/or less precise set of values in accordance with a mapping scheme that defines, for each value in the larger and/or more precise set, a mapping to a corresponding value in the smaller and/or less precise set.

Such a mapping scheme, in some cases, makes use of one or more scaling factors and, optionally, one or more constant values. In these cases, quantizing the neural network involves quantizing at least a portion of the values associated with the neural network by determining a scaling factor and applying the scaling factor to each value in the portion of the values associated with the neural network and then, optionally, adding the one or more constant values.

The scaling factor indicates how values in a larger range and/or with a higher precision to be quantized are mapped to corresponding values in a smaller range and/or with a lower precision, by scaling the values in the larger and/or more precise set of values to correspond to a quantized value in the smaller and/or less precise set of values. Calculating the scaling factor can vary depending on the quantization technique used (e.g., symmetric quantization vs. asymmetric quantization).

There are many different rounding schemes that can be used for converting the values associated with the neural network, including round to nearest, round toward zero, stochastic rounding, to name just a few examples. In some implementations, a particular rounding scheme can be specified as a part of the updated quantization configuration 130, e.g., based on the use case of the quantized neural network.

A value occupies a certain number of bits in computer memory. Depending on the ranges of values used in computing, different numbers of bits can be allocated in the computer memory. In computing, and, in particular, in the field of artificial intelligence (AI) and machine learning (ML), values are often represented either in an integer format or a floating-point format. Examples of integer formats include 8-bit signed (int8), 8-bit unsigned (uint8) 16-bit (int16), 32-bit (int32), to name a few. Examples of floating-point formats include half-precision (float16), single-precision (float32), Brain Floating Point (bfloat 16), to name a few.

Converting the values associated with the neural network from an initial format, e.g., a larger range and/or precision format, to a compact format, e.g., a smaller range and/or precision format, therefore, means that fewer bits will be needed to allocate in the computer memory (e.g., in a logical data storage area or physical data storage device) for each parameter when storing the neural network. Accordingly, the memory footprint of the neural network is reduced (despite that the total number of parameters of the neural network stays the same). More specifically, at each of the multiple iterations, the updated quantization configuration 130 for the neural network can define which computer number format(s) should be used to represent at least a portion of the values associated with the neural network at the iteration.

In some implementations, the updated quantization configuration 130 can specify that all values associated with the neural network are to be represented using the same computer number format. In other implementations, the updated quantization configuration 130 can specify that different sets of values associated with the neural network are to be represented using different computer number formats.

For example, the updated quantization configuration 130 can define that (i) a first computer number format should be used to represent the values of the activation generated by the layers of the neural network, and (ii) a second computer number format should be used to represent the values of the parameters of the layers of the neural network. The first computer number format and the second computer number can each be a respective one of the integer formats or floating-point formats mentioned above, or some other known computer number formats.

As another example, the updated quantization configuration 130 can define that even values of different portions of parameters of the same layer of the neural network should be represented using different computer number formats. For example, the updated quantization configuration 130 can define that (i) a first computer number format should be used to represent the values of a first subset of parameters of a layer of the neural network, and (ii) a second computer number format should be used to represent the values of a second subset of the parameters of the layer of the neural network.

In other words, the updated quantization configuration 130 can divide a quantization range for a parameter tensor of a neural network into a first region and a second region, and specify that values of the parameter tensor in the first region should be represented using a different computer number format than the values of the parameter tensor in the second region. For example, different scaling factors may be applied to values in different regions of the parameter tensor of the neural network.

To generate the updated quantization configuration 130, at each of the multiple iterations across the profile-guided quantization process, the quantization system 100 determines an estimated quantization metric for each of a plurality of predetermined computer number formats.

For example, the estimated quantization metric can be in the form of an estimated quantization error, which is an estimation of an error which can be, or be dependent on, a loss in accuracy that would potentially be incurred if the values associated with the neural network were to be quantized to a corresponding predetermined computer number format, i.e., if the values associated with the neural network were to be represented by the corresponding predetermined computer number format. Other types of quality-related metrics that do not specifically measure an error have also been contemplated.

Estimating such a quantization error allows the quantization system 100 to identify one or more updated computer number formats that are suitable for representing values associated with the neural network without actually having to execute any additional machine learning workloads.

The accuracy and, correspondingly, the quantization error can be evaluated by using a loss function, which can be any appropriate loss function for the machine learning task. Generally, the loss function includes one or more terms that measure, for each network input, the quality of a neural network output for the neural network input generated by performing a forward pass through the neural network, e.g., relative to a respective target output for the neural network input. For example, the one or more terms can be cross entropy loss terms, mean squared error loss terms, negative log likelihood loss terms, and so on.

Repeatedly executing a machine learning workload for each of the plurality of predetermined computer number formats can be computationally intensive and can consume a significant amount of computational resources when the neural network is a large-scale neural network that has a large number of parameters, when there exists a large number of predetermined computer number formats to evaluate, or both. By estimating the quantization errors based on the profiles 120, the quantization system 100 can reduce the amount of computational resources consumed by the error determination process because executing a machine learning workload over all predetermined computer number formats to determine the corresponding quantization errors is no longer required.

In particular, the estimated quantization errors can be determined based at least in part on the profiles 120. For example, the quantization system 100 can estimate such a quantization error based on the statistical profile, topological profile, or both of each of the plurality of layers of the neural network. For example, the quantization system 100 can determine a lower quantization error when more than a threshold number or percentage of the values of the parameters (or, analogously, the activations) of the layers fall within some certain ranges, and, analogously, determine a higher quantization error when more than a threshold number or percentage of the values of the parameters (or, analogously, the activations) of the layers fall outside some certain ranges.

In some implementations, the estimated quantization errors can additionally be determined based on the scaling factor(s) that are being used to quantize the neural network. For example, the quantization error can be in proportion to an absolute value of a scaling factor; that is, the quantization system 100 can determine a lower quantization error when the scaling factor(s) are no greater than a threshold value, and, analogously, determine a higher quantization error when the scaling factor(s) are greater than the threshold value.

In some implementations, the estimated quantization errors can further be determined based on the metadata that identifies the target runtime environment within which the neural network will be deployed. For example, the quantization system 100 can determine a lower quantization error for certain computer number formats, e.g., a computer number format that has a particular precision or a particular mix-precision, than other formats, when the target runtime environment includes specialized (e.g., dedicated) hardware that is optimized for performing operations in those computer number formats, e.g., normal-precision format arithmetic operations, quantized-precision format arithmetic operations, or mixed-precision arithmetic operations.

After having determined the estimated quantization error for each of the plurality of predetermined computer number formats, the quantization system 100 selects, from the plurality of predetermined computer number formats, one or more computer number formats based on the estimated quantization errors for the plurality of predetermined computer number formats. The quantization system 100 then generates the updated quantization configuration 130 based on the selected computer number format(s).

For example, the quantization system 100 can select one or more computer number formats that have the lowest estimated quantization errors among the estimated quantization errors of all predetermined computer number formats. As another example, the quantization system 100 can select one or more computer number formats that have the estimated quantization errors that are lower than a given threshold quantization error.

Then, the quantization system 100 compiles the source code for the neural network in accordance with the updated quantization configuration 130 to generate machine code 140 for an updated quantized version of the neural network. If the current iteration is not the last iteration, the quantization system 100 will perform a machine learning workload at the beginning of the next iteration of the profile-guided quantization process based on executing the machine code 140 for the updated quantized version of the neural network that has been generated in the current iteration.

If the current iteration is the last iteration, the quantization system 100 uses the updated quantization configuration 130 as the optimized (e.g., final) quantization configuration for the neural network. That is, the optimized quantization configuration for the neural network is the updated quantization configuration 130 that is generated in the last iteration of the profile-guided quantization process.

Furthermore, if the current iteration is the last iteration, the quantization system 100 compiles the source code for the neural network in accordance with the optimized quantization configuration to generate machine code for an updated quantized version of the neural network, and uses the generated machine code as the machine code 104 for the final quantized version of the neural network. Once the machine code 104 for the final quantized version of the neural network has been generated, the quantization system 100 outputs the machine code 104 to the runtime environment 110.

The runtime environment 150 then deploys the neural network that has the final quantized version on the one or more computing devices 112 to perform inference. That is, the runtime environment 150 uses the neural network, which has the final quantized version determined by the quantization system 100 by performing the profile-guided quantization process, to generate new outputs for the machine learning task for new inputs.

For example, the runtime environment 150 can receive an input to be processed from a user, e.g., through an API or another data interface provided by the runtime environment 150, perform a task on the input by using the neural network to process the input, and provide an output generated by the neural network or data derived from the generated output in response to the received input.

The final quantized version can enable a reduced size and/or reduced compute representation of the values associated with the deployed neural network, e.g., a reduced size representation of the parameter data, activation data, or both of deployed the neural network. The reduced memory footprint can enable power efficient inferencing and can enable processing of larger neural networks by the runtime environment 150.

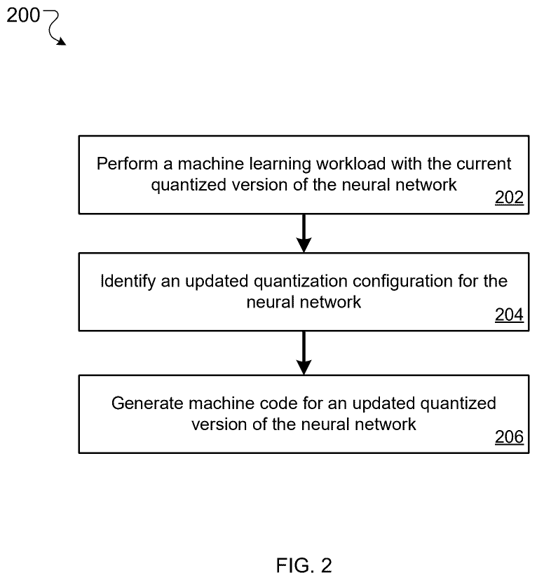

FIG. 2 is a flow diagram of an example process 200 for generating machine code for a final quantized version of a neural network. For convenience, the process 200 will be described as being performed by a system of one or more computers located in one or more locations. For example, a quantization system, e.g., the quantization system 100 depicted in FIG. 1, appropriately programmed in accordance with this specification, can perform the process 200.

Prior to the first iteration of process 200, the system receives source code for a neural network and, optionally, the metadata that includes information about a target runtime environment. The neural network includes a plurality of layers. Each layer includes a respective set of parameters. The system then performs iterative operations to obtain machine code for a final quantized version of the neural network. Thereafter, the system outputs the machine code for the final quantized version of the neural network for deployment at a runtime environment, e.g., the runtime environment 110 depicted in FIG. 1.

The system processes a machine learning workload with a current quantized version of the neural network (step 202). Additionally, the system monitors the performance, e.g., tracks the behavior of the neural network which has the current quantized version on the machine learning workload.

For the first iteration of process 200, the current quantized version of the neural network can have the same version as the neural network defined by the source code, i.e., the version of the neural network used during the development, training, and/or evaluation of the neural network. Alternatively, for any subsequent iteration of process 200, the current quantized version of the neural network can be an updated quantized version of the neural network that has been generated in accordance with an updated quantization configuration identified from an immediately preceding iteration of process 200.

For example, as a part of performing the machine learning workload, the system can execute a forward pass of the neural network by processing a neural network input to generate a neural network output. Optionally, when the machine learning workload is a training workload, having generated the neural network output, the system can execute a backward pass of the neural network to update the parameter values of the neural network using backpropagation.

In some implementations, the performance monitoring enables failure recovery capability of the system. Upon determining that the performance of the neural network that has the current quantized version has degraded by at least a predefined amount relative to a performance of the neural network that has a previous quantized version, the system can switch to execute the machine code for the neural network that has the previous quantized version. For example, the performance of the quantized neural network comprises an accuracy of outputs generated by the neural network while performing the machine learning workload.

The system identifies an updated quantization configuration for the neural network based on information obtained through performing the machine learning workload with the current quantized version of the neural network (step 204). For each of the plurality of layers of the neural network, the updated quantization configuration defines one or more updated computer number formats for representing the activation values generated by the layer. Additionally or alternatively, for each of the plurality of layers of the neural network, the updated quantization configuration defines one or more updated computer number formats for representing the respective set of parameters of the layer.

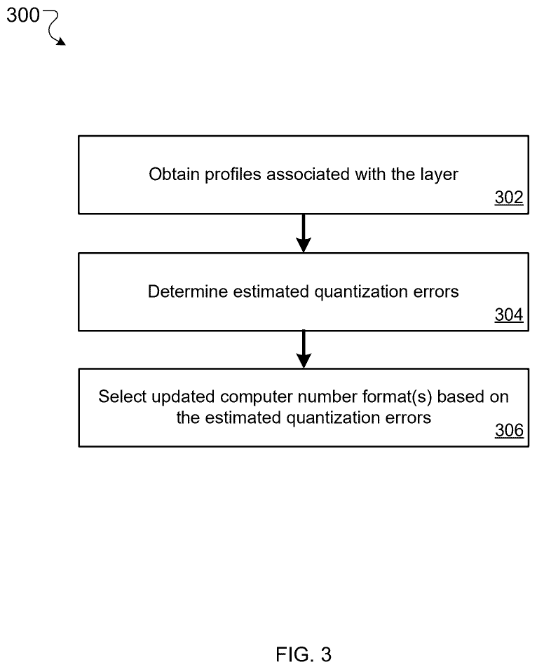

Identifying the updated quantization configuration is described in more detail below with reference to FIG. 3, which is a flow diagram of sub-steps 302-304 of the step 204 of the process 200, but generally, the system will identify different updated quantization configuration at different iterations of the process 200.

Merely as an example, at the first iteration, the updated quantization configuration that can be identified the system will define that a normal-precision floating-point format should be used to represent (i) the activation values generated by the layer, (ii) the respective set of parameters of the layer, or both (i) and (ii). Then, at the second iteration, the updated quantization configuration that can be identified the system will define that a quantized-precision floating-point format, e.g., a lower-precision floating-point format, should be used to represent (i) the activation values generated by the layer, (ii) the respective set of parameters of the layer, or both (i) and (ii).

For each of the plurality of layers of the neural network, the system obtains a profile associated with the layer based on the monitored performance, e.g., the tracked behavior, of the neural network on the machine learning workload (step 302). In some implementations, the profile is a statistical profile that includes statistical information about values of inputs, outputs (i.e., the activations), or the parameters (e.g., weights and, optionally, biases) of the layer when processing the neural network inputs for the machine learning workload. In some implementations, the profile is a topological profile that includes topological information about the layer. In some implementations, the profiles include both statistical profiles and topological profiles.

For each of the plurality of layers of the neural network, the system determines, for each of a plurality of computer number formats, an estimated quantization error (step 304). The estimated quantization error is an estimation of an error which can be, or be dependent on, a loss in accuracy that would potentially be incurred if the values associated with the layer of the neural network were to be quantized to a corresponding computer number format, i.e., if the values associated with the layer of the neural network were to be represented by the corresponding computer number format.

In particular, the estimated quantization error can be determined based at least in part on the profiles. In some implementations, the estimated quantization error can be determined additionally based on (i) the scaling factors that are being used to quantize the neural network, (ii) the metadata that identifies the target runtime environment within which the neural network will be deployed, or both (i) and (ii).

Suppose, for example, the corresponding computer number format is int8 (where the maximum representable value is 127), one way to convert the values to int8 is rounding to the nearest integer (RN). Let A be a matrix having N×K entries that represent values associated with the neural network, the scaling factors sᵢ of A can be computed as sᵢ=maxⱼ(|Aᵢⱼ|)/127, and the scaled (quantized) matrix can be computed as [symbol] =Aᵢⱼ/Sᵢ.

In this example, the quantization error can be computed as Èᵢⱼ= [symbol] (Ãᵢⱼ) where RN indicates the rounding operation. The error incurred by the unscaled matrix can be computed as Eᵢⱼ=Sᵢ [symbol] =sᵢ( [symbol] -RN(Ãᵢⱼ)). Accordingly, the squared quantization error can be computed as ∥E∥²=Σᵢⱼs²ᵢ( [symbol] )-RN(Ãᵢⱼ))².

Moreover, in practice it is possible to replace the squared error term ( [symbol] -RN(Ãᵢⱼ))² with a constant to save time needed to compute such an error, e.g., 1/12 when rounding to the nearest integer (RN) is used or ⅙ when stochastic rounding is used, because for many input distributions the distance from the nearest integer can be treated as effectively a uniform random variable. Thus the expected value of the random variable can be used as a close approximation.

For each of the plurality of layers of the neural network, the system selects, from the plurality of computer number formats, one or more updated computer number formats based on the estimated quantization errors for the plurality of computer number formats (step 306). After having selected the one or more updated computer number formats, the system can then generate the updated quantization configuration based on the updated computer number formats.

For example, the system can select, as the one or more updated computer number formats, one or more computer number formats that have the lowest estimated quantization errors among the estimated quantization errors of all computer number formats. As another example, the system can select, as the one or more updated computer number formats, one or more computer number formats that have the estimated quantization errors that are lower than a given threshold quantization error.

In some implementations, the system selects the same updated computer number format to represent all values associated with the neural network, while in other implementations, the system selects different updated computer number formats to represent different sets of values associated with the neural network.

Referring back to FIG. 2, the system compiles the source code for the neural network to generate machine code for an updated quantized version of the neural network (step 206). In particular, the system generates the machine code in accordance with the updated quantization configuration.

Step 206 can be performed by making use of a compiler. A compiler includes a computer program that transforms (e.g., translates) source code written in a high-level programming language into machine code specified in a programming language (typically a lower-level programming language) that is different than the source code through a series of phases.

For example, the compiler can apply a series of phases that include lexical analysis, parsing, semantic analysis, optimization, and code generation to transform the source code into the machine code. At each of one or more of the phases in this example, e.g., at the optimization phase, the compiler can modify attributes of the machine code to define which computer number formats should be used to represent which values associated with the neural network, according to the updated quantization configuration.

After having performed each iteration of process 200, the system can determine whether a termination condition is satisfied, e.g., whether a predetermined number of iterations have been performed, whether a predetermined amount of time has lapsed, whether the estimated quantization error is below a threshold value, and the like.

If the termination condition is satisfied, the system can then apply the updated quantization configuration as the optimized quantization configuration. Alternatively, if the termination condition is not satisfied, the system can then apply the updated quantized version of the neural network as the current quantized version of the neural network in a next processing iteration of process 200.

By repeatedly performing multiple iterations of process 200, the system can obtain the machine code for the final quantized version of the neural network. The machine code for the final quantized version of the neural network is the machine code for the updated quantized version of the neural network that is generated based on the updated quantization configuration identified by the system in the last iteration of process 200.

When repeatedly performing the multiple iterations of process 200, the system performs multiple compilations of the source code to generate multiple versions of machine code that are potentially different from each other. Generally, however, the system can do so without requiring any changes to the source code. In other words, the system need not make any changes to the source code throughout the multiple iterations of process 200. This eliminates errors that might be caused by source code changes.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which can be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A computer-implemented method comprising:
receiving source code for a neural network, the neural network comprising a plurality of layers, each layer comprising a respective set of parameters;
generating an optimized quantization configuration for the neural network that defines, for each of the plurality of layers, one or more optimized computer number formats for activation values generated by the layer, the respective set of parameters for the layer, or both, wherein generating the optimized quantization configuration includes iteratively:
processing a machine learning workload with a current quantized version of the neural network, wherein the current quantized version of the neural network was compiled in accordance with a current quantization configuration that defines, for each of the plurality of layers, one or more current computer number formats for activation values generated by the layer, the respective set of parameters for the layer, or both;
based on information obtained through processing the machine learning workload with the current quantized version of the neural network, identifying an updated quantization configuration for the neural network, the updated quantization configuration defining, for each of the plurality of layers, one or more updated computer number formats for activation values generated by the layer, the respective set of parameters of the layer, or both; and
compiling the source code for the neural network in accordance with the updated quantization configuration to generate machine code for an updated quantized version of the neural network, wherein the updated quantization configuration is applied as the optimized quantization configuration if a termination condition is satisfied, wherein the updated quantized version of the neural network is applied as the current quantized version of the neural network in a next processing iteration if the termination condition is not satisfied.

2. The method of claim 1, wherein identifying the updated quantization configuration for the neural network comprises, for each of the plurality of layers of the neural network:
obtaining a profile associated with the layer, the profile comprising (i) statistical information about values of inputs, outputs, or the parameters of the layer, (ii) topological information about the layer; and
determining, for each of a plurality of computer number formats and based on the profile, an estimated quantization error that is an estimation of a quantization error that would be incurred if the layer were to be quantized into the computer number format.

3. The method of claim 2, wherein determining the estimated quantization error comprises:
determining, based on the profile, one or more scaling factors to be applied to the values of inputs, outputs, or the parameters of the layer; and
determining the estimated quantization error based on the one or more scaling factors and the profile.

4. The method of claim 2, wherein identifying the updated quantization configuration for the neural network comprise, for each of the plurality of layers of the neural network:
selecting, from the plurality of computer number formats, a computer number format based on the estimated quantization errors for the plurality of computer number formats.

5. The method of claim 2, wherein performing the machine learning workload with the current quantized version of the neural network comprises:
executing machine code for the current quantized version of the neural network that was generated in accordance with a previously identified quantization configuration.

6. The method of claim 1, wherein the machine learning workload is a neural network inference workload.

7. The method of claim 1, wherein the machine learning workload is a neural network training workload.

8. The method of claim 1, wherein identifying the updated quantization configuration for the neural network comprise:
identifying the updated quantization configuration based on a performance of the current quantized version of the neural network on the machine learning workload.

9. The method of claim 8, wherein the performance comprises an accuracy of outputs generated by the current quantized version of the neural network.

10. The method of claim 8, wherein performing the machine learning workload with the current quantized version of the neural network comprises:
determining that the performance of the current quantized version of the neural network has degraded by at least a predefined amount relative to a performance of a previous quantized version of the neural network; and
in response, switching to perform the machine learning workload with the previous quantized version of the neural network.

11. The method of claim 1, wherein generating the final quantization configuration for the neural network does not include making any changes to the source code.

12. The method of claim 1, further comprising deploying a final quantized neural network in a runtime environment that comprises one or more computing devices and one or more memory devices.

13. A system comprising one or more computers and one or more storage devices storing instructions that are operable, when executed by the one or more computers, to cause the one or more computers to perform operations comprising:
receiving source code for a neural network, the neural network comprising a plurality of layers, each layer comprising a respective set of parameters;
generating an optimized quantization configuration for the neural network that defines, for each of the plurality of layers, one or more optimized computer number formats for activation values generated by the layer, the respective set of parameters for the layer, or both, wherein generating the optimized quantization configuration includes iteratively:
processing a machine learning workload with a current quantized version of the neural network, wherein the current quantized version of the neural network was compiled in accordance with a current quantization configuration that defines, for each of the plurality of layers, one or more current computer number formats for activation values generated by the layer, the respective set of parameters for the layer, or both;
based on information obtained through processing the machine learning workload with the current quantized version of the neural network, identifying an updated quantization configuration for the neural network, the updated quantization configuration defining, for each of the plurality of layers, one or more updated computer number formats for activation values generated by the layer, the respective set of parameters of the layer, or both; and
compiling the source code for the neural network in accordance with the updated quantization configuration to generate machine code for an updated quantized version of the neural network, wherein the updated quantization configuration is applied as the optimized quantization configuration if a termination condition is satisfied, wherein the updated quantized version of the neural network is applied as the current quantized version of the neural network in a next processing iteration if the termination condition is not satisfied.

14. The system of claim 13, wherein identifying the updated quantization configuration for the neural network comprises, for each of the plurality of layers of the neural network:
obtaining a profile associated with the layer, the profile comprising (i) statistical information about values of inputs, outputs, or the parameters of the layer, (ii) topological information about the layer; and
determining, for each of a plurality of computer number formats and based on the profile, an estimated quantization error that is an estimation of a quantization error that would be incurred if the layer were to be quantized into the computer number format.

15. The system of claim 14, wherein determining the estimated quantization error comprises:
determining, based on the profile, one or more scaling factors to be applied to the values of inputs, outputs, or the parameters of the layer; and
determining the estimated quantization error based on the one or more scaling factors and the profile.

16. The system of claim 14, wherein identifying the updated quantization configuration for the neural network comprise, for each of the plurality of layers of the neural network:
selecting, from the plurality of computer number formats, a computer number format based on the estimated quantization errors for the plurality of computer number formats.

17. The system of claim 14, wherein performing the machine learning workload with the current quantized version of the neural network comprises:
executing machine code for the current quantized version of the neural network that was generated in accordance with a previously identified quantization configuration.

18. The system of claim 13, wherein the machine learning workload is a neural network inference workload.

19. The system of claim 13, wherein the machine learning workload is a neural network training workload.

20. A computer storage medium encoded with instructions that, when executed by one or more computers, cause the one or more computers to perform operations comprising:
receiving source code for a neural network, the neural network comprising a plurality of layers, each layer comprising a respective set of parameters;
generating an optimized quantization configuration for the neural network that defines, for each of the plurality of layers, one or more optimized computer number formats for activation values generated by the layer, the respective set of parameters for the layer, or both, wherein generating the optimized quantization configuration includes iteratively:
processing a machine learning workload with a current quantized version of the neural network, wherein the current quantized version of the neural network was compiled in accordance with a current quantization configuration that defines, for each of the plurality of layers, one or more current computer number formats for activation values generated by the layer, the respective set of parameters for the layer, or both;
based on information obtained through processing the machine learning workload with the current quantized version of the neural network, identifying an updated quantization configuration for the neural network, the updated quantization configuration defining, for each of the plurality of layers, one or more updated computer number formats for activation values generated by the layer, the respective set of parameters of the layer, or both; and
compiling the source code for the neural network in accordance with the updated quantization configuration to generate machine code for an updated quantized version of the neural network, wherein the updated quantization configuration is applied as the optimized quantization configuration if a termination condition is satisfied, wherein the updated quantized version of the neural network is applied as the current quantized version of the neural network in a next processing iteration if the termination condition is not satisfied.
